(19) United States
(12) Patent Application Publication
(10) Pub. No.: US 2013/0120251 A1
(43) Pub. Date: May 16, 2013

(54) SYSTEM AND METHOD FOR MUTUALLY CONTROLLING ELECTRONIC DEVICES

(71) Applicant: SAMSUNG ELECTRONICS CO. LTD., Suwon-si (KR)

(72) Inventors: Wookwang LEE, Suwon-si (KR); Chijung HA, Suwon-si (KR)

(73) Assignee: SAMSUNG ELECTRONICS CO. LTD., Suwon-si (KR)

(21) Appl. No.: 13/667,574

(22) Filed: Nov. 2, 2012

(30) Foreign Application Priority Data
Nov. 15, 2011 (KR) 10-2011-0118804

(51) Int. Cl. G09G 5/08; G09G 5/00

(52) U.S. Cl. 345/157; 345/156

(57) ABSTRACT

A system and a method for an electronic device among a plurality of electronic devices connected to each other to control at least one other electronic device among the plurality of electronic devices are provided. The method includes detecting whether a first electronic device of the plurality of electronic devices connects to a second electronic device of the plurality of electronic devices, performing, when the first electronic device and the second electronic devices are connected to each other, an enumeration process where the first electronic device and the second electronic device both transmit and receive information regarding their respective drivers to each other; and controlling the second electronic device using an input unit of the first electronic device and controlling the first electronic device using an input unit of the second electronic device.

### PRIORITY

This application claims the benefit under 35 U.S.C. §119(a) of a Korean patent application filed on Nov. 15, 2011 in the Korean Intellectual Property Office and assigned Serial No. 10-2011-0118804, the entire disclosure of which is hereby incorporated by reference.

### BACKGROUND OF THE INVENTION

1. Field of the Invention

The present invention relates to a system and method that allows one of a plurality of electronic devices connected to each other to control at least one other electronic device from among the plurality of electronic devices.

2. Description of the Related Art

With the rapid development of information and communication technology and semiconductor technology, the use of various types of electronic devices, including mobile electronic devices, has also increased. Mobile electronic devices may employ mobile convergence to provide additional services typically provided by other types of electronic systems and devices in addition to the traditional services provided by the mobile electronic devices. For example, mobile communication devices include their usual communication functions, such as voice calling or message transmission, and additional functions as well, such as a Television (TV) viewing function (e.g., mobile broadcasting, such as Digital Multimedia Broadcasting (DMB), Digital Video Broadcasting (DVB), and other similar media and video services), an audio playback function (e.g., Motion Picture Experts Group (MEPG) Audio Layer 3 (MP3)), a photographing and video recording function, a data communication function, an Internet function, a short-range Radio Frequency (RF) communication function, and other similar functions that may be provided on a mobile communications device. Electronic devices are also equipped with a connection function so as to connect to other electronic devices. However, the connection function between electronic devices may be limited to an output function where one electronic device transmits a screen image to the other electronic devices.

### SUMMARY OF THE INVENTION

Aspects of the present invention are to address the above-mentioned problems and/or disadvantages and to provide at least the advantages described below. Accordingly, an aspect of the present invention is to provide a system and method that allows one of a plurality of electronic devices connected to each other to control at least one other electronic device from among the plurality of electronic devices.

In accordance with an aspect of the present invention, a method for mutually controlling a plurality of electronic devices is provided. The method includes detecting whether a first electronic device of the plurality of electronic devices connects to a second electronic device, performing, when the first electronic device and the second electronic device are connected to each other, an enumeration process where the first electronic device and the second electronic device both transmit and receive information regarding their respective drivers to each other, and controlling the second electronic device using an input unit of the first electronic device and controlling the first electronic device using an input unit of the second electronic device.

In accordance with another aspect of the present invention, a system for mutually controlling electronic devices including a first electronic device and a second electronic device is provided. The system includes a first electronic device, and a second electronic device, the first electronic device and the second electronic device are connected to each other and the first electronic device and the second electronic device both perform an enumeration process where for transmitting and receiving information regarding respective drivers. The first electronic device is controlled using an input unit of the second electronic device and the second electronic device is controlled using an input unit of the first electronic device.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a configuration view of a system according to an exemplary embodiment of the invention;

FIG. 2 illustrates a flowchart of a method for allowing electronic devices to mutually control other electronic devices, according to an exemplary embodiment of the invention;

FIG. 3 illustrates a schematic block diagram of a first electronic device and a second electronic device, according to an exemplary embodiment of the invention; and

FIGS. 4 to 7 illustrate screens when a first electronic device and a second electronic device are connected to each other and are mutually controlled by the other, according to an exemplary embodiment of the invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

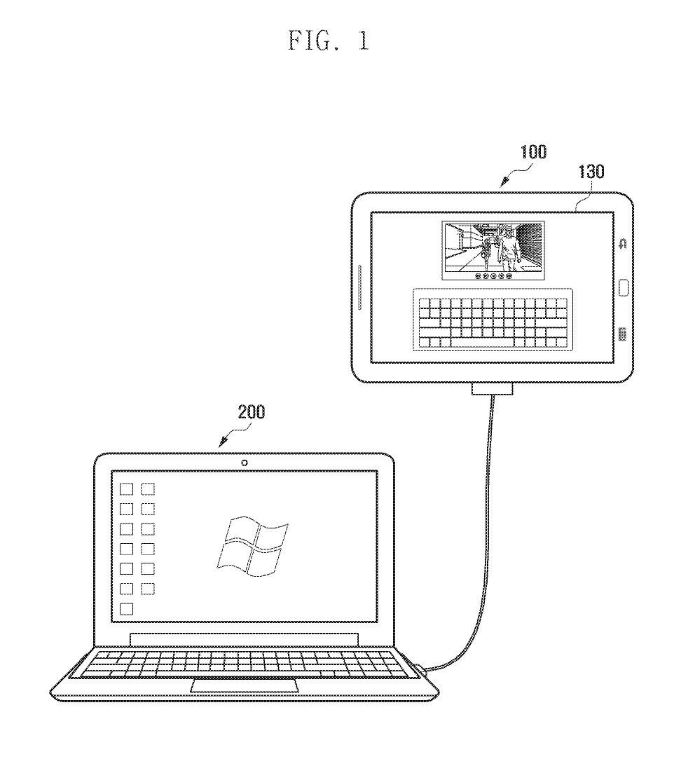

FIG. 1 illustrates a configuration view of a system according to an exemplary embodiment of the invention.

Referring to FIG. 1, the system includes a first electronic device 100 and a second electronic device 200.

The system allows one of a plurality of electronic devices that are connected to each other to control the others of the plurality of electronic devices. For example, when the first electronic device 100 and second electronic device 200 are connected to each other, the first electronic device 100 may serve as a sub-monitor of the second electronic device 200 and the user may control the second electronic device 200 via an input unit (not shown) of the first electronic device 100, the input unit being for inputting information, commands and data into the first electronic device 100. On the other hand, the second electronic device 200 may serve as a sub-monitor of the first electronic device 100 and the user may control the first electronic device 100 via an input unit (not shown) of the second electronic device 200, the input unit being for inputting information, commands and data into the second electronic device 200. The following exemplary embodiment is described in such a way that the first electronic device 100 and the second electronic device 200 are implemented with a tablet Personal Computer (PC) and a laptop computer, respectively. However, the present invention is not limited thereto, and the first electronic device 100 and the second electronic device 200 may be any suitable electronic device and/or mobile electronic device.

The first electronic device 100, which is the tablet PC, includes a touch screen 130, and does not have a physical keyboard, i.e., a keyboard input unit having individual physical keys. When the first electronic device 100 is connected to the second electronic device 200, it serves as a sub-monitor for the second electronic device 200. In such a case, the first electronic device 100 receives screen data for a dual monitor display, so as to display duplicated screen data or extended screen data, from the second electronic device 200 and displays the screen data on the touch screen 130. The first electronic device 100 transmits a control signal, via the input unit of the first electronic device 100, to the second electronic device 200. For example, the first electronic device 100 detects touch signals via the touch screen 130 and transmits them to the second electronic device 200 in order to control the second electronic device 200. As such, the first electronic device 100 may serve as a sub-monitor and an input unit for the second electronic device 200.

The second electronic device 200, which is a laptop computer, includes a physical keyboard, a pointing unit, which is an input device such as a mouse device, a touchpad, or other similar input unit or device. When the second electronic device 200 is connected to the first electronic device 100, the second electronic device 200 transmits the screen data for the dual monitor display, so as to display duplicated screen data or extended screen data, to the first electronic device 100. When the second electronic device 200 receives control signals from the first electronic device 100 that are transmitted via the input unit of the first electronic device 100, the second electronic device 200 performs functions corresponding to the received control signals. That is, the user may control the second electronic device 200 via the touch screen 130 of the first electronic device 100.

On the other hand, the second electronic device 200 may also receive screen data from the first electronic device 100 and may display the screen data on a display unit of the second electronic device 200. In that case, the user may control the first electronic device 100 via the input device of the second electronic device 200. That is, the user may control the first electronic device 100 via the keyboard or the pointing unit of the second electronic device 200. Additionally, when the first 100 and second 200 electronic devices attempt to connect to each other, they may also perform an enumeration process for exchange information regarding their respective drivers so that they may be mutually connected.

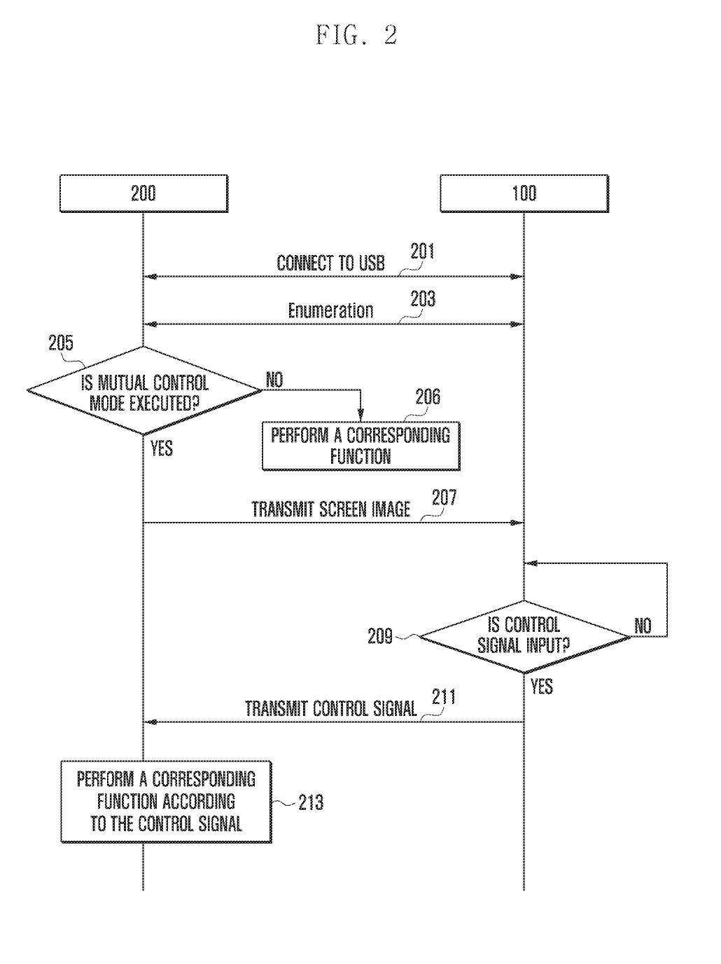

FIG. 2 illustrates a flowchart of a method for allowing electronic devices to mutually control other electronic devices, according to an exemplary embodiment of the invention.

Referring to FIGS. 1 and 2, the first electronic device 100 and the second electronic device 200 are connected to each other, via, for example, a Universal Serial Bus (USB) connection, at step 201. Although the present exemplary embodiment is described in such a way that the devices 100 and 200 are connected via the USB connection, the present invention is not limited thereto, and any suitable connection type may be used, including wired and wireless connection types. For example, the connection mode may also be achieved via a serial or parallel communication mode. Additionally, the first electronic device 100 and the second electronic device 200 also perform an enumeration process to exchange information regarding their respective drivers at step 203. After completing the enumeration process at step 203, the second electronic device 200 determines whether a mode for mutually controlling electronic devices, such as a mutual electronic device control mode, is executed at step 205. The mutual electronic device control mode includes a first control mode, where the second electronic device 200 is controlled via the input unit of the first electronic device 100, and a second control mode, where the first electronic device 100 is controlled via the input unit of the second electronic device 200. In the following description, the present exemplary embodiment is explained based on the first control mode.

When the second electronic device 200 determines that the mutual electronic device control mode is not executed at step 205, the second electronic device 200 performs a corresponding function at step 206. For example, the second electronic device 200 operates in a mode independent of the first electronic device 100 or determines the first electronic device 100 to be a storage unit, or any other similar mode of operation. On the contrary, when the second electronic device 200 determines that the mutual electronic device control mode is executed at step 205, the second electronic device 200 transmits the screen data to the first electronic device 100 at step 207. The screen data may serve to display the same screen on both respective monitors of the first electronic device 100 and the second electronic device 200, which is called duplicated screen data, or may display an extended view of a screen of the second electronic device 200 over both monitors of the first electronic device 100 and the second electronic device 200, which is called extended screen data. To this end, the second electronic device 200 encodes the screen data and transmits it to the first electronic device 100 via the USB driver of the second electronic device 200. The USB driver transmits the encoded screen data to the first electronic device 100 via a bulk transmission method or any other suitable transmission method. The first electronic device 100 receives the encoded screen data and then decodes and displays the encoded screen data on the touch screen 130. To this end, the first electronic device 100 includes a USB gadget driver.

Next, the first electronic device 100 determines whether a control signal for controlling the second electronic device 200 is input via the touch screen 130 at step 209. When the first electronic device 100 determines that there is the control signal for controlling the second electronic device 200 via the touch screen 130 at step 209, then the first electronic device 100 transmits the detected control signal to the second electronic device 200 at step 211. The control signal of the first electronic device 100 includes coordinates of a touch on the touch screen 130, which are detected via the touch driver. That is, the coordinates of the touch are transmitted to the second electronic device 200 via a USB interrupt transmission. The second electronic device 200 receives the control signal and performs a corresponding function at step 213. As described above, the first electronic device 100 displays the duplicated screen data or the extended screen data for the second electronic device 200 on the touch screen 130. Accordingly, the user may control the second electronic device 200 via the touch screen 130 of the first electronic device 100.

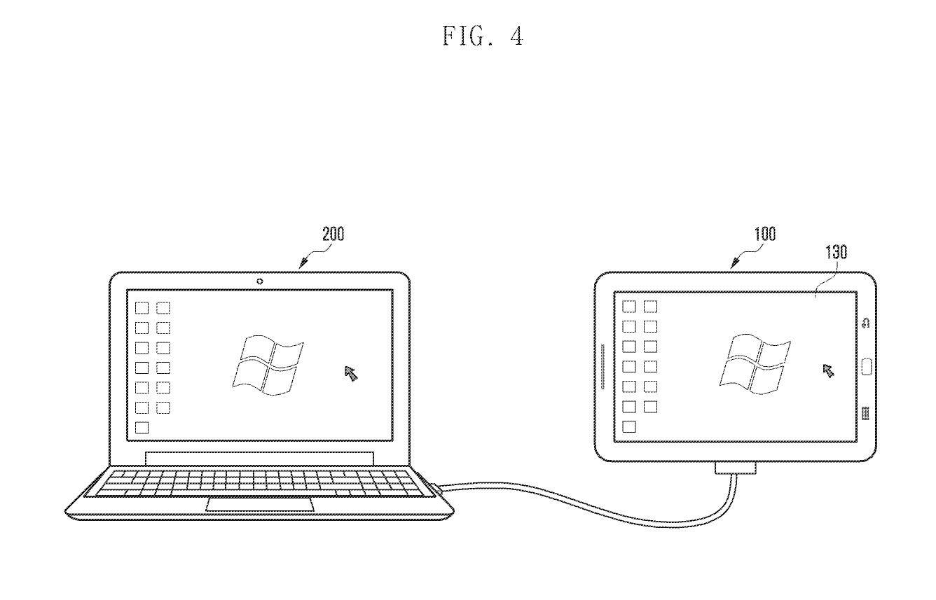

Although the exemplary embodiment of FIG. 2 is not described in a case where a mode altering signal is input, the system of FIG. 2 may allow the user to control the first electronic device 100 via the input unit of the second electronic device 200. To this end, the first electronic device 100 and the second electronic device 200 may switch between their respective screens according to a corresponding condition. The screen switching operation will be described in detail with reference to FIGS. 4 to 7.

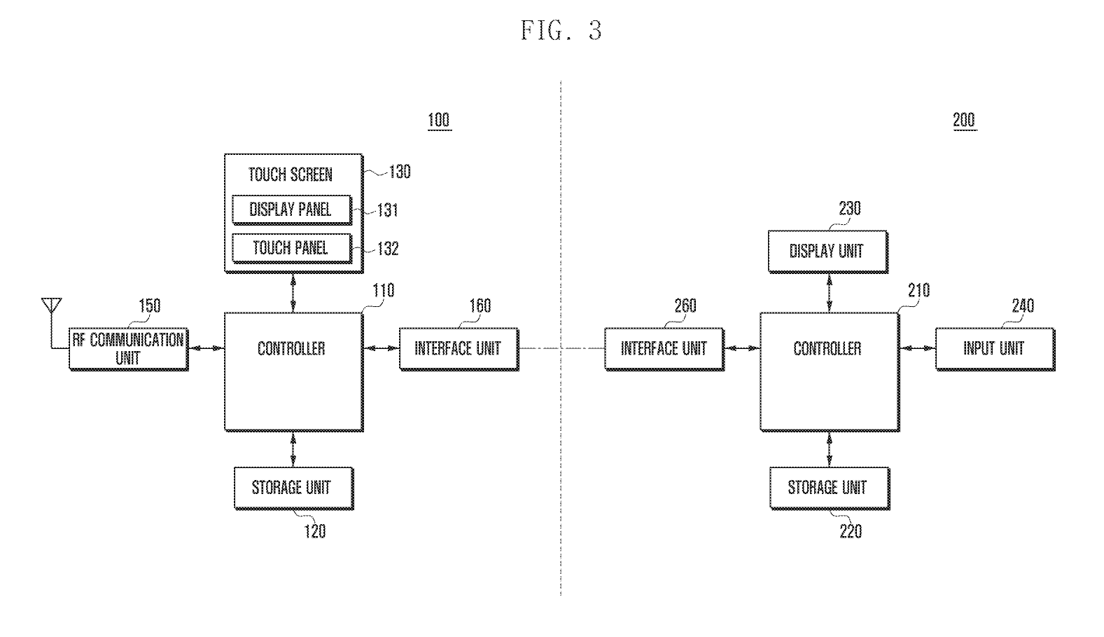

FIG. 3 illustrates a schematic block diagram of a first electronic device and a second electronic device, according to an exemplary embodiment of the invention.

Referring to FIGS. 1 to 3, the first electronic device 100 includes an interface unit 160, a Radio Frequency (RF) communication unit 150, a touch screen 130, a storage unit 120, and a controller 110.

The RF communication unit 150 establishes a communication channel with a base station of a wireless communication system and performs a voice or video call, data communication, or other similar wireless communications. The RF communication unit 150 includes an RF transmitter (not shown) for up-converting the frequency of signals to be transmitted and amplifying the signals and also includes an RF receiver (not shown) for low-noise amplifying received RF signals and down-converting the frequency of the received RF signals. When the first electronic device 100 is implemented in such a way that it does not provide a wireless communication function, it may not include the RF communication unit 150.

The touch screen 130 serves to perform a display function and an input function. To this end, the touch screen 130 includes a display panel 131 and a touch panel 132.

The display panel 131 displays menus of the first electronic device 100 and may display information input by the user or information provided to the user. The display panel 131 provides various types of screens according to the operations of the first electronic device 100, such as an idle screen (which may be a home screen), menu screens, a message writing screen, a call screen, a schedule screen, a contact screen, or any other similar or suitable screen. When the first electronic device 100 is connected to the second electronic device 200 and operates in the first mode described above with reference to FIG. 2, the display panel 131 displays a screen transmitted from the second electronic device 200. For example, the display panel 131 displays the duplicate screen or the extended screen of the second electronic device 200. On the other hand, when the first electronic device 100 operates in the second mode described above with reference to FIG. 2, the display panel 131 may display a screen of the first electronic device 100. The operation of the display panel 131 will be described in detail below, referring to FIGS. 4 to 7. The display panel 131 may be implemented with a Liquid Crystal Display (LCD), an Organic Light Emitting Diode (OLED), an Active Matrix Organic Light Emitting Diodes (AMOLED), or any other similar or suitable display apparatus.

The touch panel 132 is attached to the display panel 131. The touch panel 132 senses a touch or a touch event via a touch input object such as a user's finger, a stylus pen, or other similar or suitable touch input objects, and transfers a corresponding signal to the controller 110. The touch panel 132 senses and identifies types of touches, such as a tap, a drag, a flick, a double touch, a long touch, a multi touch, or any other similar touch type or touch event, by detecting the change in a physical quantity, such as a change in capacitance, a change in resistance, or any other similar or suitable change in a physical quantity, according to a touch at a touch area by a touch input object. The touch panel 132 transfers a signal corresponding to the sensed touch and the touch location information to the controller 110. When the first electronic device 100 and the second electronic device 200 are connected to each other and operate in the first mode, the touch panel 132 serves as an input unit for controlling the second electronic device 200. On the other hand, when the first electronic device 100 is connected to the second electronic device 200 and operates in the second mode, the touch panel 132 serves as an input unit for controlling the first electronic device 100.

The interface unit 160 connects to the second electronic device 200. The interface unit 160 may be implemented with a device following the USB or micro-USB standard. However, the present invention and the interface unit 160 are not limited thereto. For example, the interface unit 160 may be implemented with various types of communication standards, such as a serial communication standard, a parallel communication standard, or any other similar or suitable communication standard.

The storage unit 120 stores an Operating System (OS) of the first electronic device 100. The storage unit 120 also stores application programs required for executing the optional functions, such as, an audio playback function, image or video playback function, broadcast reproducing function, or any other similar and suitable application programs that may be executed on the first electronic device 100. The storage unit 120 also stores a user's input data and data transmitted or received during communication operations. For example, the storage unit 120 stores a key map or menu map to operate the touch screen 130. The key map or menu map may be implemented in various modes. For example, the key map may be a keyboard map, a 3×4 key map, a QWERTY key map, or any other similar map for inputting information. The key map may also be a control key map for controlling an application program that is currently activated. The storage unit 120 also stores video files, game files, audio files, movie files, and other similar user data. The storage unit 120 stores information regarding drivers to connect to the second electronic device 200. The driver information may be used during the enumeration process, as discussed above, with the second electronic device 200. The storage unit 120 stores information regarding a USB gadget driver to decode screen data from the second electronic device 200 and to display the decoded screen data on the touch screen 130. The storage unit 120 also stores information regarding a touch driver for controlling the touch panel 132.

The controller 110 controls operations of the first electronic device 100 and the signals flowing between the components in the first electronic device 100. The controller 110 also performs a data processing function. In an exemplary embodiment of the present invention, when the first electronic device 100 and the second electronic device 200 are connected to each other, the controller 110 performs an enumeration process with respect to the second electronic device 200. After completing the enumeration process, the controller 110 receives screen data from the second electronic device 200 and controls the display panel 131 so as to display images corresponding to the received screen data. After that, the controller 110 receives touch signals via the touch panel 132 and transmits the received touch signals to the second electronic device 200. When the controller 110 receives a mode switching signal via the touch panel 132, the controller 110 transmits the screen data of the first electronic device 100 to the second electronic device 200. After that, the controller 110 receives control signals from the second electronic device 200 via an input unit 240 of the second electronic device 200, and the controller 110 performs a corresponding function of the first electronic device 100.

Additionally, the second electronic device 200 includes an interface unit 260, an input unit 240, a display unit 230, a storage unit 220, and a controller 210.

The display unit 230 displays information input by a user of the second electronic device 200 or information provided to the user. The display unit 230 displays various types of screens when the second electronic device 200 is activated or turned on, such as a background screen, an application execution screen, or any other similar and suitable screens. The display unit 230 displays a screen of the second electronic device 200 in the first mode. That is, the display unit 230 displays screens according to signals input to the touch panel 131 of the first electronic device 100 and the input unit 240 of the second electronic device 200. On the other hand, when the first 100 and second 200 electronic devices operate in the second mode, then the display unit 230 displays the screen data transmitted from the first electronic device 100. For example, the display unit 230 may display a duplicate screen or an extended screen of the first electronic device 100. The operation of the display unit 230 will be described in detail below, referring to FIGS. 4 to 7.

The input unit 240 includes input keys and function keys that receive numerical or alphabetical information which may be used to set and control a variety of functions in the second electronic device 200. The input unit 240 receives a mode switching signal. When the second electronic device 200 operates in the second mode according to the input mode switching signal, the user may control the first electronic device 100 via the input unit 240. The input unit 240 may be implemented with one of a key board, a joystick, a wheel key, a touch pad, a combination thereof, or any other similar and suitable input device or apparatus.

The interface unit 260 connects to the first electronic device 100. Since the interface unit 260 performs a similar function as the interface unit 160 of the first electronic device 100, detailed description of the interface unit 260 is omitted.

The storage unit 220 stores an OS of the second electronic device 200. The storage unit 220 also stores application programs for executing optional functions, such as an audio playback function, an image or video playback function, a broadcast reproducing function, or other similar functions. The storage unit 220 stores a user's input data and stores a control program for performing a mutual control operation between the first electronic device 100 and the second electronic device 200 that are connected to each other. The control program transmits a duplicate screen or an extended screen of the second electronic device 200 to the first electronic device 100, and, accordingly, the user controls the second electronic device 200 via the input unit of the first electronic device 100. After that, the control program controls the second electronic device 200 to perform a function according to a control signal input to the input unit 140 of the first electronic device 100. In a case where a mode switching signal is input to the second electronic device 200, the control program requests a duplicate screen or an extended screen of the first electronic device 100 from the first electronic device 100, so that the user may control the first electronic device 100 via the input unit 240 of the second electronic device 200. After that, the control program transmits the signal input to the input unit 240 to the first electronic device 100.

The storage unit 220 stores information regarding the drivers so as to connect the second electronic device 200 to the first electronic device 100. The storage unit 220 also stores a program for encoding screen data that is to be transmitted to the first electronic device 100. The storage unit 220 stores an event processing driver for processing control signals, such as touch signals, or other similar control signals, transmitted from the first electronic device 100.

The controller 210 controls the operations of the second electronic device 200 and the signals flowing between the components in the second electronic device 200. The controller 210 also performs a data processing function. When the controller 210 detects the connection between the first electronic device 100 and the second electronic device 200, then the controller 210 performs an enumeration process with respect to the first electronic device 100. After completing the enumeration process, the controller 210 determines whether a mutual control mode is executed. When the controller 210 determines that a mutual control mode is executed, the controller 210 controls the displayed screens between the first electronic device 100 and the second electronic device 200. For example, the controller 210 may transmit screen data of the second electronic device 200 to the first electronic device 100 or may control the display unit 230 to display the screens of the first electronic device 100. The display operation of the second electronic device 200 will be described in detail below, referring to FIGS. 4 to 7.

Although it is not shown in FIG. 3, the first electronic device 100 and the second electronic device 200 may selectively further include units having add-on functions, such as a short-range RF communication module, a Global Positioning System (GPS) module, a broadcast module for receiving and reproducing broadcasts, an audio source playback module, such as a Motion Picture Experts Group (MEPG) Audio Layer 3 (MP3) module, an Internet communication module for performing communication via the Internet, or any other similar and suitable unit, device or apparatus. Furthermore, in consideration of the breadth of digital convergence, although electronic devices vary too greatly to list their modifications and types that may be included in the first electronic device 100 in this description, it will be easily appreciated by those skilled in the art that the other units equivalent to the above-listed units may be further included in the first electronic device 100 and the second electronic device 200.

FIGS. 4 to 7 illustrate screens when a first electronic device and a second electronic device are connected to each other and are mutually controlled by the other, according to an exemplary embodiment of the invention.

Referring to FIGS. 1 to 7, when the first electronic device 100 and the second electronic device 200 are connected to each other, they may display a same screen. As shown in FIG. 4, the second electronic device 200 transmits a duplicate screen data to the first electronic device 100 so that both the first electronic device 100 and the second electronic device 200 display the same screen. In such a case, the user may control the second electronic device 200 via the touch screen 130 of the first electronic device 100. For example, when the user of the first electronic device 100 applies a touch gesture or a double touch gesture to an icon on the touch screen 130 of the first electronic device 100, the touch signal is transmitted to the second electronic device 200 and, accordingly, a corresponding function is executed in the second electronic device 200. Such a process has a same effect as if the user of the second electronic device 200 applies the first electronic device user's gesture (a click or a double click) to the icon on the second electronic device 200 via a pointing object, such as a mouse device. During this process, the first electronic device 100 may measure a period of time that a touch gesture is performed in order to distinguish between touch gestures corresponding to a right button click and a left button click of the mouse device, or pointing object, of the second electronic device 200. That is, if the user touches an icon for a certain period of time less than a preset period of time, the first electronic device 100 transmits a control signal corresponding to an operation of clicking the left button of the mouse device to the second electronic device 200. On the other hand, if the user touches an icon for a certain period of time equal to or greater than a preset period of time, the first electronic device 100 transmits a control signal corresponding to an operation of clicking the right button of the mouse device to the second electronic device 200.

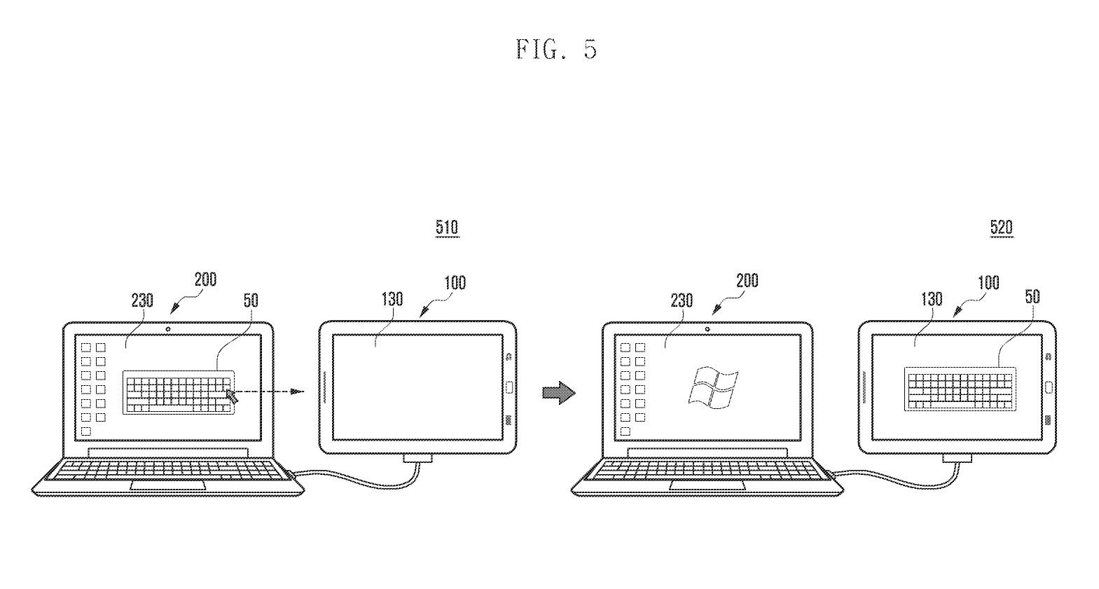

Referring to FIG. 5, when the first electronic device 100 and the second electronic device 200 are connected to each other, the first electronic device 100 displays the extended screen data of the second electronic device 200 on the touch screen 130. If the user executes an application program in the second electronic device 200, the second electronic device 200 displays the execution window on the display unit 230. In such a case, the user may move the execution screen from the display unit 230 to the touch screen 130 via a pointing object, such as the mouse device of the second electronic device 200. For example, as shown in diagrams 510 and 520, the user may create a virtual keypad 50 on the display unit 230 of the second electronic device 200 and may move the virtual keyboard to the touch screen 130 of the first electronic device 100. Accordingly, the user may also control the second electronic device 200 via the virtual keypad 50 displayed on the touch screen 130 of the first electronic device 100.

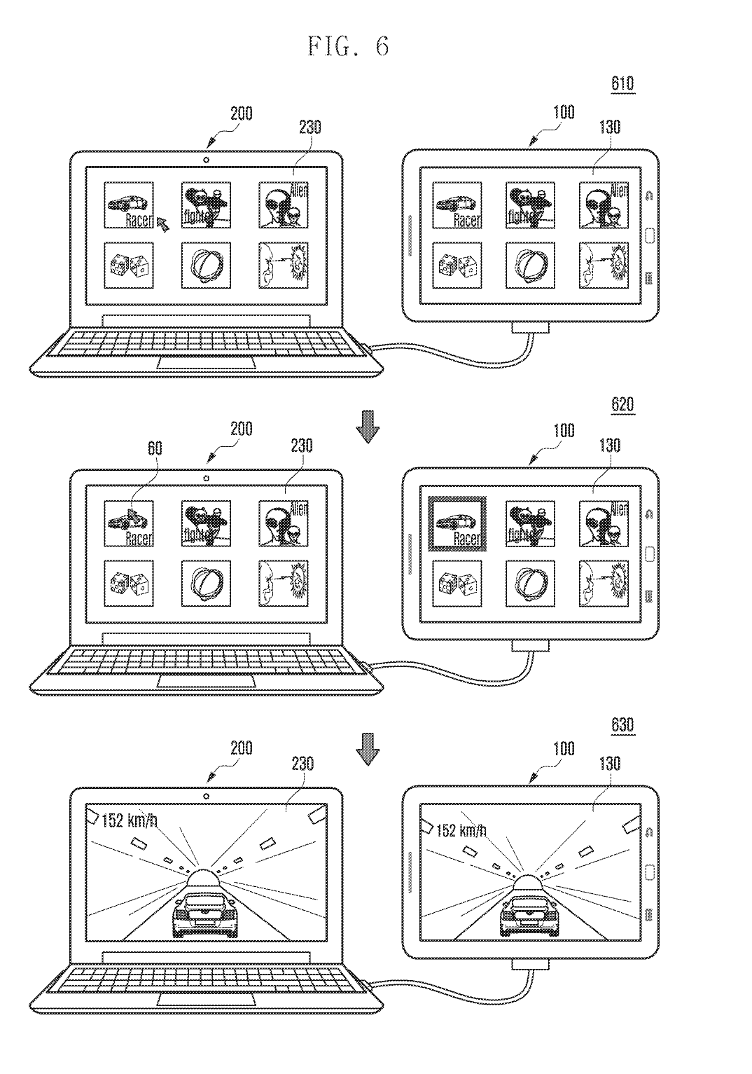

Referring to FIG. 6, when the first electronic device 100 and the second electronic device 200 are connected to each other, the second electronic device 200 displays the screen of the first electronic device 100 on the display unit 230 as shown in diagram 610. Alternatively, when a mode switching signal is input to the screen, as shown in FIG. 4, the second electronic device 200 displays the screen of the first electronic device 100 on the display unit 230. As shown in diagram 610, the second electronic device 200 may display the duplicate screen of the first electronic device 100 on the display unit 230, and further display a pointer 60. Therefore, the user may control the first electronic device 100 via a pointing object, such as a touch pad, a mouse device, or any other similar pointing object, of the second electronic device 200 to control a location of the pointer 60. For example, as shown in diagram 620, the user may select an icon via a pointing object of the second electronic device 200 that controls the location of the pointer 60, and the first electronic device 100 highlights an icon selected by the pointer 60. After that, the user may make a double-click on the selected icon via the pointing object of the second electronic device 200, and the controller 210 of the second electronic device 200 transmits a signal for executing a corresponding function to the first electronic device 100. Accordingly, the second electronic device 200 receives the execution screen, such as a game execution screen corresponding to the selected icon, from the first electronic device 100, and displays the execution screen on the display unit 230, as shown in diagram 630.

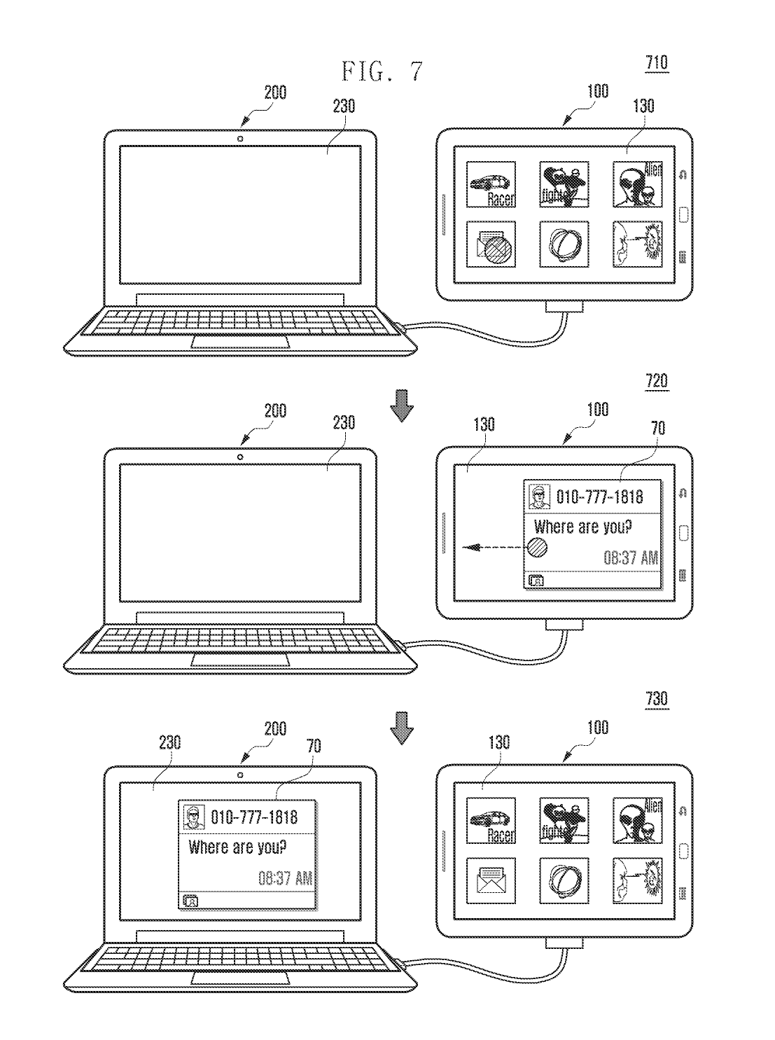

Referring to FIG. 7, when the first electronic device 100 and the second electronic device 200 are connected to each other, the second electronic device 200 displays an extended screen of the first electronic device 100 on the display unit 230, as shown in diagram 710. Alternatively, when a mode switching signal is input to the screen, as shown in FIG. 5, the second electronic device 200 displays the extended screen of the first electronic device 100 on the display unit 230. After that, the first electronic device 100 executes an application program, such as a text message transmission application, via a touch input to the touch screen 130. In that case, as shown in diagram 720, the first electronic device 100 displays the application execution screen, such as a text message writing field 70, on the touch screen 130. After that, as shown in diagrams 720 and 730, the user may move the application execution screen, which is the text message writing field 70 in the present exemplary embodiment, to the second electronic device 200 via a touch gesture, such as a drag. After that, the user may input a text message to the writing field 70 via the keyboard of the second electronic device 200 while the writing field 70 is displayed on the display unit 230. As such, the user may control an application executed in the first electronic device 100 via the input unit 240 of the second electronic device 200.

As described above, the system and method according to the present exemplary embodiments enables one of the plurality of electronic devices connected to each other to control at least one other electronic device from among the plurality of electronic devices. For example, when a laptop computer is connected to a tablet PC, the mutual control system enables the tablet PC to display a screen of the laptop computer on the touch screen of the tablet PC, and allows the user to control the laptop computer via the touch screen. As such, the mutual control system and method allows the tablet PC to serve as an input unit for the laptop computer. Likewise, the mutual control system and method displays a screen of the tablet PC on the display screen of the laptop computer, allows the user to control the tablet PC via the keyboard and mouse device of the laptop computer. Therefore, the mutual control system and method allows the laptop computer to serve as an input unit for the tablet PC.

As described above, the mutual control method according to the exemplary embodiments may be implemented with program commands that may be conducted and executed via various types of computers and may be recorded and/or stored in non-transient computer-readable recording media. The non-transient computer-readable recording media may contain and/or store program commands, data files, data structures, or the like, or a combination thereof. The program commands recorded in the non-transient computer-readable recording media may be designed or configured so as to comply with the exemplary embodiments of the present invention or may be software well-known to those of ordinary skill in the art. The non-transient computer-readable recoding media includes hardware systems for storing and executing program commands. Examples of the hardware systems are magnetic media such as a hard disk, a floppy disk, a magnetic tape, optical media such as a Compact Disk (CD)-Read Only Memory (ROM) and a Digital Versatile Disk (DVD), a Magneto-Optical Media, such as floptical disk, and hardware such as a ROM, a Random Access Memory (RAM), flash memory, or other similar and suitable types of storage devices and storage media. The program commands may include assembly language or machine code complied by a complier and a higher level language interpreted by an interpreter. The hardware systems may be implemented with at least one software module.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for mutually controlling a plurality of electronic devices, the method comprising:
detecting whether a first electronic device of the plurality of electronic devices connects to a second electronic device of the plurality of electronic devices;
performing, when the first electronic device and the second electronic device are connected to each other, an enumeration process where the first electronic device and the second electronic device both transmit and receive information regarding their respective drivers to each other; and
controlling the second electronic device using an input unit of the first electronic device and controlling the first electronic device using an input unit of the second electronic device.

2. The method of claim 1, wherein the controlling of the second electronic device using the input unit of the first electronic device comprises:
transmitting duplicate screen data of the second electronic device to the first electronic device.

3. The method of claim 1, wherein the controlling of the second electronic device using the input unit of the first electronic device comprises:
transmitting extended screen data of the second electronic device to the first electronic device.

4. The method of claim 3, further comprising:
outputting, when an application program is executed in the second electronic device, the application execution screen so as to be displayed on a display unit of the second electronic device; and
moving the application execution screen from the display unit of second electronic device to a display unit of the first electronic device.

5. The method of claim 1, wherein the controlling of the first electronic device using the input unit of the second electronic device comprises:
transmitting duplicate screen data of the first electronic device to the second electronic device.

6. The method of claim 1, wherein the controlling of the first electronic device using the input unit of the second electronic device comprises:
transmitting extended screen data of the first electronic device to the second electronic device.

7. The method of claim 6, further comprising:
outputting, when an application program is executed in the first electronic device, the application execution screen so as to be displayed on a display unit of the first electronic device; and
moving the application execution screen from the display unit of first electronic device to a display unit of the second electronic device.

8. The method of claim 1, wherein:
the input unit of the first electronic device comprises a touch screen; and
the input unit of the second electronic device comprises a keyboard and a pointing object.

9. The method of claim 1, wherein the controlling of the second electronic device using the input unit of the first electronic device and the controlling of the first electronic device using the input unit of the second electronic device is performed when a mutual control mode is executed, and
wherein the mutual control mode is for when the electronic devices are mutually controlled.

10. The method of claim 1, wherein the controlling of the first electronic device using the input unit of the second electronic device is performed when a mode switching signal is input while the second electronic device is being controlled using the input unit of the first electronic device.

11. A system for mutually controlling electronic devices, the system comprising:
a first electronic device, and
a second electronic device,
wherein the first electronic device and the second electronic device are connected to each other,
wherein the first electronic device and the second electronic device both perform an enumeration process for transmitting and receiving information regarding respective drivers, and
wherein the first electronic device is controlled using an input unit of the second electronic device and the second electronic device is controlled using an input unit of the first electronic device.

12. The system of claim 11, wherein the first electronic device receives and outputs one of duplicate screen data or extended screen data of the second electronic device.

13. The system of claim 11, wherein the second electronic device receives and outputs one of duplicate screen data or extended screen data of the first electronic device.

14. The system of claim 11, wherein the input unit of the first electronic device comprises a touch screen, and
wherein the input unit of the second electronic device comprises a keyboard and a pointing object.

15. The system of claim 14, wherein the input unit of the second electronic device receives a signal for switching a first mode, the first mode being for controlling the second electronic device using the input unit of the first electronic device, to a second mode, the second mode being for controlling the first electronic device using the input unit of the second electronic device.

16. The system of claim 15, wherein the second electronic device operates in the first mode when a mutual control mode is executed, and
wherein the second electronic device operates in the second mode when the mode switching signal is received.

17. The system of claim 11, wherein the first electronic device comprises a tablet Personal Computer (PC), and
wherein the second electronic device comprises a laptop computer.
